(19) United States
(12) Patent Application Publication
(10) Pub. No.: US 2026/0295709 A1
(43) Pub. Date: Oct. 1, 2026

(54) APPARATUS FOR SUPPLYING WELDING FILLER MATERIAL DURING JOINING OF STRIP ENDS USING WELDING TECHNOLOGY

(71) Applicant: Fritz Orbke Baustoffgroßhandlung GmbH, Erwitte (DE)

(72) Inventors: Dirk BAUMEISTER, Dortmund (DE); Oliver NAPIERALA, Bad Sassendorf (DE)

(73) Assignee: Fritz Orbke Baustoffgroßhandlung GmbH, Erwitte (DE)

(21) Appl. No.: 19/571,918

(22) Filed: Mar. 19, 2026

(30) Foreign Application Priority Data
Mar. 26, 2025 (JP) 2025-052617

(51) Int. Cl. B23K 9/133

(52) U.S. Cl. CPC B23K 9/1336

(57) ABSTRACT

In an apparatus for supplying welding filler material during joining of strip ends using welding technology, a feed nozzle for the wire-form welding filler material is arranged between pilot rollers for positioning the strip ends to be welded, pivoted at an angle relative to the welding head orientation. First and second feed nozzles for first and second wire-form welding filler materials, respectively, arranged relative to one another are movable relative to one another, so that each feed nozzle can be linearly set all the way into the region of the weld zone. The first and second feed nozzles are oriented pivoted relative to one another by an angle amount, and the first and second feed nozzles can be set only alternately, in each instance, linearly into the region of the weld zone, so that the welding filler material, in each instance, can be melted by the welding head.

### CROSS REFERENCE TO RELATED APPLICATIONS

Applicant claims priority under 35 U.S.C. § 119 of Japanese Application No. JP 2025-52617 filed Mar. 26, 2025, the disclosure of which is incorporated by reference.

### BACKGROUND OF THE INVENTION

### 1. Field of the Invention

The invention relates to an apparatus for supplying welding filler material during joining of strip ends using welding technology.

### 2. Description of the Related Art

Within the scope of processing of sheet-metal materials in the form of strips wound up into coils, joining of strips that are to be processed, one after the other, by means of laser welding as well as by means of resistance welding is widespread. The strips are joined together, from individual longer strip pieces that are generally coiled up, for example in rolling devices, for pickling or similar processing steps, and processed quasi continuously. For this purpose, the strip ends of strips to be processed one after the other are welded to one another. Such a welding station usually stands at the intake of a process line for processing of the strips. In order to guarantee a continuous processing process of the strips, the machine welds the strip end of the strip that is currently situated in the processing process, for example in a pickle or a roller mechanism, to the strip beginning of a further strip that is to be processed next. To prepare the weld seam of the strips to be welded together, a scissors cut is generally made, by means of which smooth strip ends, parallel to one another, are produced in the region of the subsequent weld connection.

In this regard, not only strips made of the same materials and material grades are joined to one another, but also different materials, sheet-metal thicknesses, and surface grades must be connected to one another, and this requires the use of different welding filler materials, in particular in the processing of conventional construction steels and ferritic steels in the strip processing line.

The welding device consists, in this regard, generally of a base frame, for example, to which clamping tables for positioning and clamping the strip ends to be positioned relative to one another are fastened. A C framework (C carriage) moves on this base frame, on which framework the cutting and welding components, including the devices for pre-heating and post-heating the welding region, are arranged. The C framework moves over the region of the strip ends, which are positioned in front of one another, and moves the welding device along the adjacent strip ends, so that these strip ends can be welded to one another. Aside from the laser welding method, resistance welding methods, such as, for example, rolled seam welding or also spot welding, are also used in such welding devices.

In the region of the weld zone, pilot rollers oriented approximately in V shape relative to one another are arranged above the weld zone, which rollers, together with rollers arranged on the underside of the weld zone, orient the strips to be connected relative to one another, and hold them in their position and location relative to one another during welding. These pilot rollers successively roll along the weld seam during the course of welding of the strips. The actual welding apparatus, such as, for example, a laser welding head, generally engages into the free space between the pilot rollers that are arranged in V shape relative to one another during this process, from above, and thereby places the welding energy directly in the weld zone. In this regard, the construction space between the pilot rollers for accommodating the welding apparatus as well as further functions is very limited.

For pre-heating and post-heating the weld region, heating devices are usually used in addition, which devices are positioned close to the weld zone, in each instance, so as to guarantee precise tempering of the weld zone, and which further restrict the accessibility of the actual weld zone for bringing the welding head and the welding filler materials required for welding the strips into the region of the weld zone. These welding filler materials are usually advanced, for this purpose, as wires rolled up onto rolls, by a wire feed unit, through a nozzle arranged in the vicinity of the weld zone, all the way into the region of the weld zone, and are melted there during welding. Since feed directly along with the welding head is not possible due to the very restricted construction space between the pilot rollers, the wire feed is usually arranged at a slanted angle inclined relative to the advancing direction of the pilot rollers. For this purpose, a feed nozzle is also arranged between the pilot rollers, but arranged pivoted at an angle relative to the welding head, which generally comes from above. Because of the very restricted space conditions and the melting behavior of the welding filler material, it is best if the feed nozzle is arranged between the pilot rollers at an angle of approximately 48°-52° relative to perpendicular, i.e. the orientation of the laser head.

If, however, different sheet-metal strips composed of conventional construction steels or ferritic stainless steels, for example, are now to be welded to one another, then very different welding filler materials must be used. This requires refitting at the conventional welding stations, during which the coiled-up wires of the wire feed unit must be replaced, threaded into the nozzle, and the wire-form welding filler material must be set relative to the weld zone once again. This, however, requires a refitting time during which the system as a whole cannot be used, and therefore causes an expensive down time of the total system. Similar down times become necessary if the roll of the wire-form welding filler material has been used up and needs to be replaced. This cannot always be undertaken during times when no welding process is being carried out, or the replacement process must already take place before the end of the roll, during such idle times, and therefore remainders of the welding filler material that can no longer be used occur.

It is already known to use two wire feeds in parallel during welding, so as to introduce larger amounts of filler material into the melt during welding. In this regard, the two wire feeds work simultaneously, however, and there is hardly any construction space restriction.

### SUMMARY OF THE INVENTION

It is therefore the task of the present invention to indicate an apparatus with which the problem of the introduction of similar or different welding filler material into the weld zone during welding of strip ends can be resolved, even in the case of restricted space conditions and with minimal replacement times.

The solution for the task is evident from the characterizing characteristics according to the invention. Further advantageous embodiments of the invention are evident from the discussion below.

The invention proceeds from an apparatus for supplying welding filler material during joining of strip ends, using welding technology, in which apparatus a feed nozzle for the wire-form welding filler material is arranged between pilot rollers for positioning the strip ends to be welded at an angle, pivoted relative to the orientation of the welding head. Such a generic apparatus is thereby developed further, in a manner according to the invention, so that a first feed nozzle for a first wire-form welding filler material and a second feed nozzle for a second wire-form welding filler material can be arranged and moved relative to one another in such a manner that each of the feed nozzles can be set linearly all the way into the region of the weld zone, wherein the first and second feed nozzle are oriented offset from one another by an angle amount, and the first and second feed nozzle can only be linearly set into the region of the weld zone alternately, in each instance, in such a manner that the corresponding welding filler material can be melted by the welding head. The arrangement, according to the invention, of two feed nozzles allows alternate introduction of two different welding filler materials, on the one hand, depending on the type of strips to be welded, but on the other hand, use of the same welding filler materials at the two feed nozzles is conceivable, to increase the capacity of the available welding filler materials. For both cases, it is advantageous that the wire-form welding filler material of one of the two feed nozzles can be replaced or filled up while the welding filler material of the other feed nozzle is being melted, and thereby down times can be reduced or completely eliminated. In this regard, the two feed nozzles are oriented in such a manner, due to the very restricted space conditions, between the pilot rollers that are arranged in V shape relative to one another, that they project into the free space between pilot rollers that are arranged in V shape relative to one another, at a different angle from one another. In this regard, however, only one of the two feed nozzles, in each instance, is actually advanced into the free space between the pilot rollers that are arranged in V shape relative to one another, to such an extent that welding filler material guided in it can actually get into the region of the weld zone and be melted there, while the other feed nozzle, in each instance, is situated in a position that is retracted from the free space between pilot rollers arranged in V shape relative to one another, and leaves the space clear for the other feed nozzle, which is in engagement, in each instance. In this way, only an insignificantly greater amount of space is needed for the two feed nozzles, which can be used alternately, as compared with the known single feed nozzle, which space is just barely enough between the pilot rollers that are arranged in V shape relative to one another, and nevertheless the greater flexibility of two different feed possibilities is achieved.

It is particularly advantageous that the first and second feed nozzles are oriented, relative to an ideal angle of the arrangement of one feed nozzle between the pilot rollers, on both sides of the ideal angle, at different angles relative to one another, and relative to the orientation of the welding head. In this way, the concept of the welding device does not have to be changed as compared to the placement of only one feed nozzle, but rather only modified slightly, without the space conditions making the use of two feed nozzles impossible. In this regard, in a further embodiment, the first feed nozzle can be oriented at a smaller angle, and the second feed nozzle at a greater angle, relative to one another and relative to the orientation of the welding head, and thereby the two feed nozzles are placed on both sides of the ideal arrangement of a single feed nozzle, and alternately engage into the space between the pilot rollers that are arranged in V shape relative to one another, to such an extent that the welding filler material of the feed nozzle that is in engagement can be melted in the weld zone. To prevent collisions, the feed nozzles can be equipped with reed sensors and permanent magnets, by means of which impermissible positions of the feed nozzles can be recognized and avoided.

It is particularly advantageous if the first feed nozzle is oriented at an angle of 42°to 46° and the second feed nozzle is oriented at an angle of 53° to 57° relative to the orientation of the welding head, pivoted relative to one another. The angle that has been recognized as being ideal until now, for placement of a feed nozzle, lies in an angle range between 48° and 52° relative to the orientation of the welding head, so that in the case of the invention being presented, the first feed nozzle is oriented slightly steeper, and the second feed nozzle is oriented slightly flatter than the angle considered to be ideal for placement of a feed nozzle.

In a first embodiment, different welding filler materials can be introduced into the region of the weld zone with the feed nozzle, depending on which materials of the strips are to be welded to one another, in each instance.

In another embodiment, however, the same welding filler materials can be introduced into the region of the weld zone, using the feed nozzles, and thereby the capacity of the available welding filler material is doubled.

In the two embodiments mentioned above, it is also conceivable, however, that the welding filler material of the one feed nozzle can be replaced, without any down time of the system, while the welding filler material from the other feed nozzle, in each instance, is being melted during welding. In this way, down times of the system, which were necessary until now to replace the welding filler material needed, in each instance, or for refilling a feed nozzle with welding filler material become unnecessary.

It is advantageous if the first and second feed nozzle are arranged and held as well as driven, in the region between the pilot rollers, in such a manner that they can be alternately linearly set from a retracted position all the way into the region of the weld zone, and retracted again. In this way, the situation is prevented that the feed nozzles and thereby also the parts of the feed device, in each instance, that are arranged behind the feed nozzles reciprocally hinder one another, in particular in the tight construction space between the pilot rollers that are arranged in V shape relative to one another.

It contributes to operational safety if the material properties of the welding filler material can be determined, preferably by way of induction, and thereby the use of incorrect welding filler materials can be reliably precluded. For this purpose, the ferromagnetic properties of the welding filler material, in each instance, can be detected, for example inductively. In this way, it can be determined whether the material of the welding filler material is a ferritic or an austenitic material, and it can also be checked whether the correct welding filler material, in each instance, was suitably selected for welding of the strip ends that are present, in each instance. In the case of a measurement using inductive sensors, changes in the conductivity and the magnetic permeability are detected, wherein the emphasis of such sensors lies, in this connection, on the recognition as to whether magnetic or non-magnetic materials are present. It is true that this technology is robust and in use in the industry in many cases, but it offers only relatively rough differentiation possibilities, and in most cases does not permit a distinction between different types of steel. Alternatively, it is also possible to use what are called Hall sensors for detection, which here can detect ferromagnetic materials in a cost-advantageous manner, even if the measurements can be easily influenced by geometric conditions during the measurement and by existing interference fields. Alternatively, magneto-restrictive sensors can also be used, in which the electrical resistance changes as a function of external magnetic fields. These sensors offer great sensitivity, which can also be used for material classification (for example for differentiation between soft steel and hard steel). A disadvantage here is the complicated signal processing of the measurement signals and the need for calibration of the sensors. Likewise, permeability sensors or Barkhausen sensors would be conceivable, by means of which the magnetic noise, i.e., direct permeability changes in the material can be detected. In this way, even statements concerning the structure state as well as hardness, steel stress, and heat treatment become possible, but it is relatively expensive and requires a complex evaluation of the measurement signals. Depending on the goal of the determination of information regarding the welding filler material, individual ones of these methods can be selected and also combined, if applicable.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a representation, purely in principle, of the arrangement of two feed nozzles 5, 5′ between the pilot rollers 1 of a known welding device for joining strip ends 9, in a position in which the first feed nozzle 5′ conveys wire-form welding filler material 4′ into the region of the weld zone 11; and

FIG. 2 shows another arrangement of the feed nozzles 5, 5′ between the pilot rollers 1 according to FIG. 1, in which the second feed nozzle 5 conveys wire-form welding filler material 4 into the region of the weld zone 11.

### DETAILED DESCRIPTION OF PREFERRED EMBODIMENTS

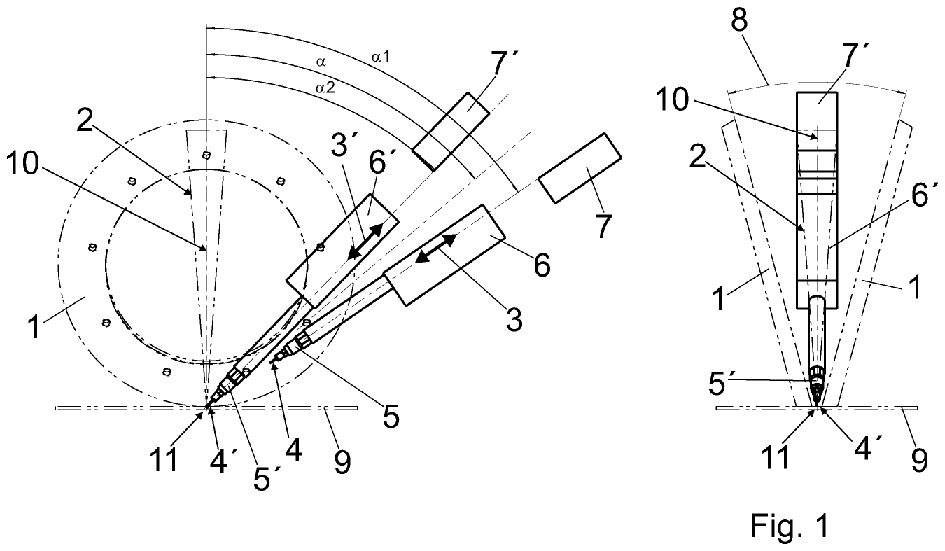

In FIG. 1, a representation, purely in principle, is shown of the arrangement of two feed nozzles 5, 5′ between the pilot rollers 1 arranged in V shape, at an angle 8 relative to one another, of an actually known welding device for joining strip ends 9, in a position in which the first feed nozzle 5′ conveys wire-form welding filler material 4′ into the region of the weld zone 11.

The welding device, which is actually known, is used for joining strip ends 9 in pass-through devices, for example, and will be described here only to the extent that is necessary to understand the present invention. The welding device has a welding head 2, configured as a laser welding head here, which emits a laser beam 10, perpendicular from above, into the region of a weld zone 11, and thereby greatly heats the metal sheets 9 to be connected, in the region of the weld zone 11. The metal sheets 9 are oriented by means of two pilot rollers 1 that are arranged in V shape relative to one another, above the metal sheets 9, and temporarily fixed in place relative to one another. Below the metal sheets 9, a type of counter-holding roller is arranged, which cannot be seen in detail in FIG. 1, and against which the pilot rollers 1 press the metal sheets 9.

The welding filler material 4, 4′ required for welding is supplied in the form of wire-form sections that are rolled up on rolls outside of the representation of FIG. 1, and are conveyed by conveying devices that are also not shown in any detail, all the way to a feed nozzle 5′, 5, of which the feed nozzle 5′ is arranged in the vicinity of the weld zone 11, and from there exits out of the feed nozzle 5′ and is melted under the effect of the laser beam 10.

In the case of conventional welding devices, only one such feed nozzle 5 is provided due to the restricted space conditions between the pilot rollers 1, so as to convey a wire-form welding filler material 4 into the region of the weld zone 11.

For welding of different strip materials, it can be advantageous to convey different welding filler materials 4, 4′, in each instance, into the region of the weld zone 11, without having to newly fill the feed nozzle 5 completely with the welding filler material 4, in each instance, in a complicated manner, something that generally brings about undesirable and cost-intensive down times of the welding device. Such a feed nozzle 5 is generally arranged oriented at an angle α relative to the incidence direction of the laser beam 10, since then the feed of the wire-form welding filler material 4 can take place optimally.

Because of the very constricted space conditions between the pilot rollers 1, which are arranged in V shape relative to one another, however, simple doubling of the feed nozzle 5 for alternatively or, if applicable, additionally supplying wire-form welding filler materials 4, 4′ is not possible.

For this reason, it is proposed, to solve the problem, to implement an arrangement according to the invention, of two feed devices for welding filler materials 4, 4′, which can be operated alternatively, in that two feed nozzles 5, 5′ that actually have the same structure and function in the same way are arranged to pivot relative to one another, and can be operated alternately, in each instance. The basic idea consists in using the small installation space that is available between the pilot rollers 1, which are arranged in V shape relative to one another, essentially twice as a result, in that only one of the feed nozzles 5 or 5′, in each instance, projects so far in between the pilot rollers 1 that it comes to lie in the region of the weld zone 11 and there delivers the wire-form welding filler material 4 or 4′, respectively, into the weld zone 11. If a different welding filler material 4′ or 4 is to be processed, this feed nozzle 5 or 5′, which has been used until now, is retracted so far that space occurs between the pilot rollers 1 that are arranged in V shape relative to one another, for the other feed nozzle 5′ or 5, in each instance, and this nozzle can now dispense the welding filler material 4, 4′ that it carries into the weld zone 11. This arrangement can also be used to double the capacity of the same welding filler material 4, 4′ that can be processed, in that the switch between the feed nozzles 5′ or 5 that has already been described is used for this purpose.

To implement this alternate operation of the feed nozzles 5 or 5′, the feed nozzles 5 or 5′ are equipped, in each instance, with setting devices 6, 6′, not shown in any detail, which can adjust the feed nozzles 5 or 5′ in the setting or adjustment direction 3, 3′, in each instance, in the direction toward the weld zone 11 or away from the weld zone 11. In order to recognize the position of the feed nozzles 5 or 5′, in each instance, relative to the weld zone 11, and to be able to prevent collisions of the feed nozzles 5 or 5′ with one another, reed contacts and permanent magnets, not shown in any detail, are affixed on the back side of the setting devices 6, 6′, which contacts and magnets can detect the position, in each instance, of the feed nozzles 5 or 5′.

In order to recognize the material properties of the welding filler material 4, 4′, in each instance, if applicable also of the strip end 9, and to avoid the use of incorrect welding filler materials 4, 4′, the ferromagnetic properties of the welding filler material 4, 4′, in each instance, and, if applicable, also of the strip end 9, can be detected, for example inductively, by way of corresponding sensors such as, for example, magnetic indicators 7, 7′. In this way, it can be determined whether the material of the welding filler material 4, 4′ and/or of the strip end 9 is a ferritic or austenitic material, and it can be checked if the suitable welding filler material 4, 4′, in each instance, for welding the strip ends that are present, in each instance, was suitably selected. Corresponding sensors can detect the ferromagnetic properties, for example, of the welding filler material, in each instance, for example inductively or also using what are called Hall sensors; alternatively, magneto-restrictive sensors or permeability sensors or Barkhausen sensors are also conceivable. Depending on the goal of the collection of data regarding the welding filler material, as well as on the need of precise or less precise certainty of the measurement, individual ones of these measurement sensors can be selected and can also be combined, if applicable.

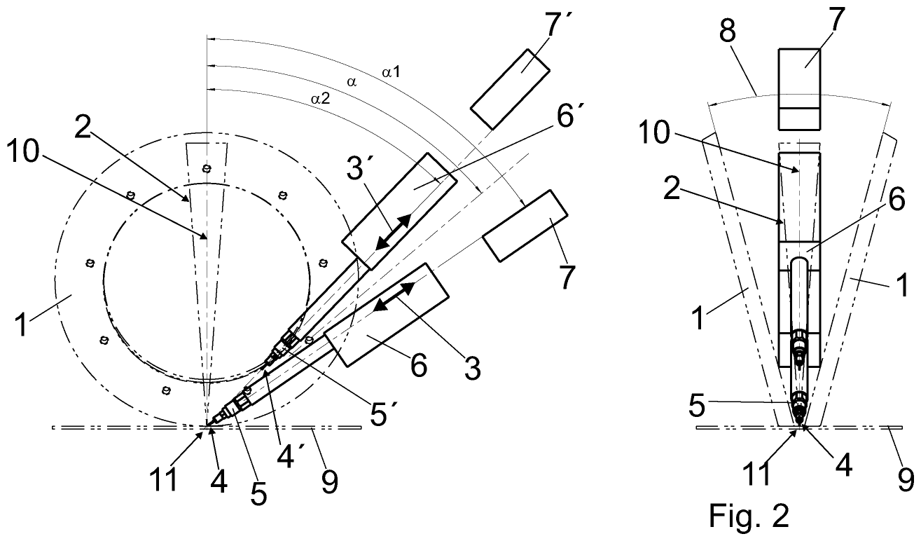

In FIGS. 1 and 2, the two positions of the feed nozzles 5 or 5′, as described above, can be seen. In this regard, it can also be recognized that the feed nozzles 5 or 5′ are arranged inclined relative to one another, on both sides of a pivot position, around the angle α, which angle indicates the pivot position of an ideal setting of a feed nozzle 5. In this regard, the feed nozzle 5′ is pivoted by an angle α2 that is slightly less than α. In this regard, the feed nozzle 5 is pivoted by an angle α1 that is slightly greater than α.

Typical values of these angles can be, for example:
Angle α, ideal feed angle, for example 48°-52°
Angle α1, increased angle clockwise, for example 53°-57°
Angle α2, reduced angle counterclockwise, for example 42°-46°

Although only a few embodiments of the present invention have been shown and described, it is to be understood that many changes and modifications may be made thereunto without departing from the spirit and scope of the invention.

### REFERENCE NUMBER LIST

1—pilot roller
2—welding head
3, 3′—adjustment direction of feed nozzle
4, 4′—tip of welding wire
5, 5′—feed nozzle
6, 6′—setting device
7, 7′—magnetic indicator
8—opening region between pilot rollers
9—metal sheets
10—laser beam
11—weld zone

What is claimed is:

1. An apparatus for supplying welding filler material during joining of strip ends (9) using welding technology, in which a feed nozzle (5, 5′) for the wire-form welding filler material (4) is arranged between pilot rollers (1) for positioning the strip ends (9) to be welded, pivoted at an angle (α) relative to the orientation (10) of the welding head (2),
wherein
a first feed nozzle (5) for a first wire-form welding filler material (4) and a second feed nozzle (5′) for a second wire-form welding filler material (4′) are arranged relative to one another and can be moved relative to one another in such a manner that each of the feed nozzles (5, 5′) can be linearly (6, 6′) set all the way into the region of the weld zone (11),
the first and second feed nozzles (5, 5′) are oriented pivoted relative to one another by an angle amount,
the first and second feed nozzle (5, 5′) can only be set alternately, in each instance, linearly (6, 6′) into the region of the weld zone (11), in such a manner that the welding filler material (4, 4′), in each instance, can be melted by the welding head (2).

2. The apparatus according to claim 1, wherein the first and second feed nozzle (5, 5′) are oriented, relative to an ideal angle (α) of the arrangement of a feed nozzle (5), pivoted relative to one another, between the pilot rollers (1), on both sides of the ideal angle, and relative to the orientation of the welding head (2).

3. The apparatus according to claim 1, wherein the first feed nozzle (5′) is oriented at a smaller angle (α2) and the second feed nozzle (5) is oriented at a greater angle (α1) relative to the orientation of the welding head (2), relative to one another.

4. The apparatus according to claim 1, wherein the one feed nozzle (5′) is oriented at an angle (α2) of 42° to 46° and the other feed nozzle (5) is oriented at an angle (α1) of 53° to 57°, relative to the orientation of the welding head (2), pivoted relative to one another.

5. The apparatus according to claim 1, wherein different welding filler materials (4, 4′) can be introduced into the region of the weld zone (11), using the feed nozzles (5, 5′).

6. The apparatus according to claim 1, wherein the same welding filler materials (4, 4′) can be introduced into the region of the weld zone (11), using the feed nozzles (5, 5′).

7. The apparatus according to claim 1, wherein the welding filler material (4) of the one feed nozzle (5) can be replaced, without any downtime of the system, while the welding filler material (4′) from the other feed nozzle (5′), in each instance, is melted during welding, and vice versa.

8. The apparatus according to claim 1, wherein the first and second feed nozzle (5, 5′) are arranged in the region between the pilot rollers (1) and held in place as well as driven (6, 6′), in such a manner that they can be alternately linearly (3, 3′) set from a retracted position all the way into the region of the weld zone (11), and retracted again.

9. The apparatus according to claim 1, wherein the material properties of the welding filler material (4, 4′) can be detected, preferably by way of induction and/or using what are called Hall sensors and/or magneto-restrictive sensors and/or permeability sensors or Barkhausen sensors.
